(19) United States
(12) Patent Application Publication
(10) Pub. No.: US 2013/0207760 A1
(43) Pub. Date: Aug. 15, 2013

(54) MULTIPOLE MAGNET

(71) Applicants: James Anthony Clarke, Warrington (GB); Benjamin John Arthur Shepherd, Warrington (GB); Neil Marks, Warrington (GB); Norbert Collomb, Warrington (GB)

(72) Inventors: James Anthony Clarke, Warrington (GB); Benjamin John Arthur Shepherd, Warrington (GB); Neil Marks, Warrington (GB); Norbert Collomb, Warrington (GB)

(21) Appl. No.: 13/877,841

(22) PCT Filed: Oct. 4, 2011
(86) PCT No.: PCT/GB11/51879

§ 371 Date: Apr. 4, 2013

(30) Foreign Application Priority Data
Oct. 7, 2010 (GB) 1016917.5

(51) Int. Cl. H01F 7/02

(52) U.S. Cl. CPC H01F 7/02
USPC 335/302

(57) ABSTRACT

A multipole magnet for deflecting a beam of charged particles, comprising: a plurality of ferromagnetic poles arranged in a pole plane; a plurality of permanent magnets each having a magnetisation direction, and each being arranged to supply magnetomotive force to the plurality of ferromagnetic poles to produce a magnetic field along the pole plane in a beamline space between the poles; and a plurality of ferromagnetic flux conducting members arranged to channel magnetic flux from at least one of the plurality of permanent magnets; wherein the multipole magnet comprises an even number of ferromagnetic poles, each pole being arranged to diametrically oppose another of the poles in the pole plane along a pole axis, wherein each of the plurality of permanent magnets is associated with at least one of the plurality of poles and the magnetisation direction of each permanent magnet isorientated in the pole plane at an angle of at least 45° relative to the pole axis of the associated pole.

This invention relates to an improved multipole magnet, and more specifically, although not exclusively, to an improved multipole magnet that includes permanent magnets and is suitable for deflecting, focusing or otherwise altering the characteristics of a beam of charged particles.

### BACKGROUND

Multipole magnets consist of a plurality of magnetic poles and, among other things, are used to deflect, focus or otherwise alter the characteristics of beams of charged particles in particle accelerators. Multipole magnets may be used to change the overall direction of a beam, focus or defocus a beam, or correct aberrations in a beam. The suitability of a multipole magnet for performing these tasks is determined largely by the number of magnetic poles present. Quadrupole magnets having four magnetic poles, for example, are particularly suitable for focusing and defocusing a beam of charged particles. In modern particle accelerator beamlines, hundreds of multipole magnets may be employed along a single beamline. In proposed future beamlines, thousands of multipole magnets are likely to be required for a single beamline.

The magnets used in multipole magnet arrangements may be electromagnets, consisting of a current carrying wire coiled around a ferromagnetic pole, or permanent magnets, which are inherently magnetized.

Electromagnets typically require an expensive power supply and may also require cooling means to remove the heat produced by the current carrying coils. The cooling means may comprise, for example, a plumbing system capable of circulating a coolant, or an airflow system for circulating cooled air. Any cooling system will incur additional set-up and running costs associated with each multipole magnet and will also require sufficient space around the multipole magnets in which to operate.

In contrast, permanent magnet multipole magnets do not require a power supply or a cooling system. An example of a permanent magnet multipole magnet is described in US-A-2002/0158736 (Gottschalk S.C.). The Gottschalk multipole magnet includes a plurality of ferromagnetic poles and one or more permanent magnets that are moveable relative to the poles to produce a variable magnetic field between the poles.

It is an object of the present invention to provide an improved multipole magnet that includes permanent magnets and is advantageous over the multipole magnets of the prior art.

### BRIEF SUMMARY OF THE DISCLOSURE

In accordance with a first aspect of the present invention, there is provided a multipole magnet for deflecting a beam of charged particles, comprising:
a plurality of ferromagnetic poles arranged in a pole plane;
a plurality of permanent magnets each having a magnetisation direction, and each being arranged to supply magnetomotive force to the plurality of ferromagnetic poles to produce a magnetic field along the pole plane in a beamline space between the poles; and
a plurality of ferromagnetic flux conducting members arranged to channel magnetic flux from at least one of the plurality of permanent magnets;
wherein the multipole magnet comprises an even number of ferromagnetic poles, each pole being arranged to diametrically oppose another of the poles in the pole plane along a pole axis, wherein each of the plurality of permanent magnets has at least one of the plurality of poles associated with it where the magnetisation direction of each permanent magnet is orientated in the pole plane at an angle of at least 45° relative to the pole axis of the associated pole.

In a preferable embodiment, the magnetisation direction of each permanent magnet is orientated in the pole plane at an angle of less than or equal to 135° relative to the pole axis of the associated pole. In a further or alternative preferable embodiment, the magnetisation direction of each permanent magnet is orientated in the pole plane at an angle of 75° relative to the pole axis of the associated pole. In another alternative preferable embodiment, the magnetisation direction of each permanent magnet is orientated in the pole plane at an angle of at least 90° relative to the pole axis of the associated pole. In another alternative embodiment, the magnetisation direction of each permanent magnet is orientated in the pole plane at an angle of 120° relative to the pole axis of the associated pole.

In any of the above described embodiments, the multipole magnet is capable of producing a high quality magnetic field that does not require a power supply or cooling system, and which can be constructed within a minimal volume. Thus, the multipole magnet is particularly suited for use in beamlines where space is particularly restricted (e.g. in a shielded enclosure, such as a tunnel) or where the reduction in heat dissipation into the surrounding space is a constraint. Given that no power supply is required, large numbers of these multipole magnets can be operated at a considerably lower cost compared with a similar number of electromagnetic multipole magnets.

In preferable embodiments, at least one of the plurality of permanent magnets and the plurality of ferromagnetic flux conducting members is moveable in the pole plane relative to the plurality of ferromagnetic poles so as to vary the strength of the magnetic field in the beamline space. This preferable feature provides the multipole magnet with adjustability whereby the magnetic flux density in the beamline space is controlled by controlling the displacement of the at least one of the plurality of permanent magnets and the plurality of ferromagnetic flux conducting members.

Preferably, each ferromagnetic flux conducting member is in a spaced arrangement from an associated ferromagnetic pole, and only the plurality of permanent magnets are moveable in the pole plane relative to the ferromagnetic poles.

In an alternative preferable embodiment, each permanent magnet is moveable in the pole plane together with an associated ferromagnetic flux conducting member relative to an associated ferromagnetic pole such that substantially no relative movement between each permanent magnet and its associated ferromagnetic flux conducting member is permitted. Further preferably, the at least one of the plurality of permanent magnets and the plurality of ferromagnetic flux conducting members are moveable along the pole plane along a path orientated at an angle of 45° relative to the pole axis of the associated pole.

In one preferable embodiment, the magnetisation direction of each permanent magnet is orientated in the pole plane at an angle that is greater than 45° and less than 135° relative to the pole axis of the associated pole, and each of the plurality of permanent magnets is associated with one of the plurality of poles; and
at least some of the ferromagnetic flux conducting members comprise ferromagnetic bridges that channel magnetic flux between the permanent magnets of two adjacent poles.

In accordance with a second aspect of the present invention, there is provided a multipole magnet for deflecting a beam of charged particles, comprising:
a plurality of ferromagnetic poles arranged in a pole plane;
a plurality of permanent magnets arranged to supply magnetomotive force to at least one of the plurality of ferromagnetic poles to produce a magnetic field along the pole plane in a beamline space between the poles; and
a plurality of ferromagnetic flux conducting members arranged to channel magnetic flux from at least one of the plurality of permanent magnets;
wherein at least one of the plurality of permanent magnets and the plurality of ferromagnetic flux conducting members is moveable in the pole plane relative to the plurality of ferromagnetic poles so as to vary the strength of the magnetic field in the beamline space.

The multipole magnet is therefore capable of producing a high quality, adjustable magnetic field that does not require an external power supply or cooling system, and which can be constructed within a minimal volume. Thus, the multipole magnet is particularly suited to use in beamlines where space is particularly restricted (e.g. in a shielded enclosure, such as a tunnel) or where the reduction in heat dissipation into the surrounding space is a constraint. Given that no power supply is required, large numbers of these multipole magnets can be operated at a considerably lower cost compared with a similar number of electromagnetic multipole magnets.

Preferably, each ferromagnetic flux conducting member is in a spaced arrangement from an associated ferromagnetic pole, and only the plurality of permanent magnets are moveable in the pole plane relative to the ferromagnetic poles.

In an alternative preferable embodiment, each permanent magnet is moveable in the pole plane together with an associated ferromagnetic flux conducting member relative to an associated ferromagnetic pole such that substantially no relative movement between each permanent magnet and its associated ferromagnetic flux conducting member is permitted.

In a particularly preferable embodiment, the multipole magnet comprises an even number of ferromagnetic poles, each pole being arranged to diametrically oppose another of the poles in the pole plane along a pole axis. Preferably, the at least one of the plurality of permanent magnets and the plurality of ferromagnetic flux conducting members are moveable along the pole plane along a path orientated at an angle of 45° relative to the pole axis of the associated pole.

In a preferable embodiment, each of the plurality of permanent magnets has a magnetisation direction, and each permanent magnet has at least one of the plurality of poles associated with it, where the magnetisation direction of each permanent magnet is orientated in the pole plane at an angle of at least 45° relative to the pole axis of the associated pole.

In a preferable embodiment, the magnetisation direction of each permanent magnet is orientated in the pole plane at an angle of less than or equal to 135° relative to the pole axis of the associated pole. In a further or alternative preferable embodiment, the magnetisation direction of each permanent magnet is orientated in the pole plane at an angle of 75° relative to the pole axis of the associated pole. In another alternative preferable embodiment, the magnetisation direction of each permanent magnet is orientated in the pole plane at an angle of at least 90° relative to the pole axis of the associated pole. In another alternative embodiment, the magnetisation direction of each permanent magnet is orientated in the pole plane at an angle of 120° relative to the pole axis of the associated pole.

In any of the above described embodiments, the multipole magnet is capable of producing a high quality magnetic field that does not require a power supply or cooling system, and which can be constructed within a minimal volume. Thus, the multipole magnet is particularly suited for use in beamlines where space is particularly restricted (e.g. in a shielded enclosure, such as a tunnel) or where the reduction in heat dissipation into the surrounding space is a constraint. Given that no power supply is required, large numbers of these multipole magnets can be operated at a considerably lower cost compared with a similar number of electromagnetic multipole magnets.

In one preferable embodiment, the magnetisation direction of each permanent magnet is orientated in the pole plane at an angle that is greater than 45° and less than 135° relative to the pole axis of the associated pole, and each of the plurality of permanent magnets is associated with one of the plurality of poles; and
at least some of the ferromagnetic flux conducting members comprise ferromagnetic bridges that channel magnetic flux between the permanent magnets of two adjacent poles.

As the permanent magnet moves away from the poles, less magnetic flux goes through the poles and into the beamline space. Proximity of the permanent magnets to flux conducting members provides short circuits that act to reduce the magnetic flux density in the beamline space. Therefore, flux conducting members may be moved closer to the permanent magnets in order to create a short circuit and reduce the magnetic field strength in the beamline space. Relative movement of the permanent magnets and flux conducting members may create air gaps which also serve to reduce the magnetic flux density in the beamline space.

In one preferable embodiment, at least some of the ferromagnetic flux conducting members comprise a cap associated with at least one of the permanent magnets to channel magnetic flux therefrom.

In a further or alternative preferable embodiment, at least some of the ferromagnetic flux conducting members comprise a discontinuous shell surrounding the poles and permanent magnets.

In some preferable embodiments, the sum of ferromagnetic poles and ferromagnetic flux conducting members is greater than the number of permanent magnets.

In a further or alternative preferable embodiment, the multipole magnet is a quadrupole magnet comprising four ferromagnetic poles and two permanent magnets, wherein each of the two permanent magnets is associated with two of the poles to supply magnetomotive force thereto.

### BRIEF DESCRIPTION OF THE DRAWINGS

Embodiments of the invention are further described hereinafter with reference to the accompanying drawings, in which:

FIG. 1 is a cross sectional view along the pole plane of a four-pole quadrupole magnet according to an embodiment of the present invention;

FIG. 2 is a cross sectional view along the pole plane of a single quadrant of a four-pole quadrupole magnet according to an alternative embodiment of the present invention;

FIG. 3 is a perspective view of a single quadrant for a four-pole quadrupole magnet according to a further alternative embodiment of the present invention;

FIG. 4 is a cross sectional view along the pole plane of a single quadrant of a four-pole quadrupole magnet according to a further alternative embodiment of the present invention;

FIG. 5 is a cross sectional view along the pole plane of a single quadrant of a four-pole quadrupole magnet according to a further alternative embodiment of the present invention, where the lines of magnetic flux are also shown;

FIG. 6 is a cross sectional view along the pole plane of a single quadrant of a four-pole quadrupole magnet according to a further alternative embodiment of the present invention;

FIG. 7 is a cross sectional view along the pole plane of a single quadrant of a four-pole quadrupole magnet according to a further alternative embodiment of the present invention;

FIG. 8 is a cross sectional view along the pole plane of four complete quadrants of a four-pole quadrupole magnet according to a further alternative embodiment of the present invention;

FIG. 9 is a cross sectional view along the pole plane of a four-pole quadrupole magnet according to an embodiment of the present invention, with the lines of magnetic flux shown;

FIG. 10 is a gradient curve indicating the change of magnetic flux density in the beamline space of the quadrupole magnet of FIG. 9 in relation to displacement of the permanent magnets;

FIGS. 11 and 12 are further examples of embodiments of the present invention and each show a cross sectional view along a single quadrant of a four-pole quadrupole magnet; and

FIG. 13 is a gradient curve indicating the change of magnetic flux density in the beamline space of the quadrupole magnet of FIG. 4 in relation to the displacement of the permanent magnets and bridges.

### DETAILED DESCRIPTION

Whilst the present invention relates generally to multipole magnets having any number of poles, it is described hereinafter in relation to quadrupole magnets i.e. magnets having four poles. However, the skilled reader will appreciate that the invention is not limited to quadrupole magnets. Embodiments of the invention may be envisaged as other multipole magnets, such as dipole, sextupole and octupole.

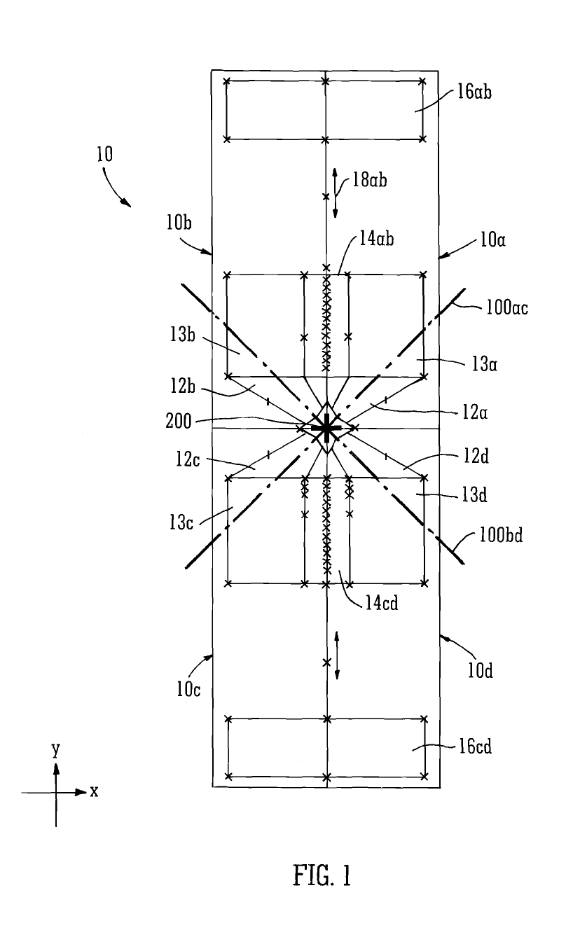

A cross sectional view of a four pole quadrupole magnet 10 according to an embodiment of the present invention is shown in FIG. 1. The quadrupole magnet 10 consists of four quadrants 10a,b,c,d where each quadrant 10a,b,c,d comprises a ferromagnetic pole 12a,b,c,d and a ferromagnetic flux conducting member extending from each of the poles 12a,b,c,d in the form of a pole root 13a,b,c,d. The cross sectional view of FIG. 1 is taken along a pole plane of the quadrupole magnet 10 which is defined as a plane about which the quadrupole magnet is symmetrical (i.e. into and out of the page) and in which all poles 12a,b,c,d of the quadrupole magnet 10 lie. A coordinate system is indicated in FIG. 1 which includes an x-axis and a y-axis that define the two-dimensions of the pole plane. A third, z-axis (not shown), extends orthogonally to both of the x-axis and the y-axis (i.e. into and out of the page).

In the pole plane, the poles 12a and 12c are arranged diametrically opposite one another along a first pole axis 100ac, while the poles 12b and 12d are arranged opposite one another along a second pole axis 100bd, where the first pole axis 100ac is orthogonal to the second pole axis 100bd in the pole plane. Within the pole plane, the four poles 12a,b,c,d define a beamline space therebetween, centered about the point of intersection 200 of the first and second pole axes 100ac,bd. In operation, a beam of charged particles, such as electrons or positrons, travels substantially orthogonally to the pole plane through the beamline space i.e. substantially parallel to the z-axis.

A moveable permanent magnet 14ab is disposed between the two pole roots 13a and 13b and a substantially identical moveable permanent magnet 14cd is disposed between the two pole roots 13c and 13d. In an alternative embodiment, each of the permanent magnets 14ab and 14cd may each be made up of two or more separate permanent magnets that may be moveable independently of one another. Furthermore, other permanent magnets may be arranged in other locations about the multipole magnet 10. Thus, the number of permanent magnets may or may not equal the number of poles.

A ferromagnetic flux conducting member 16ab is disposed radially outward of the poles 12a and 12b relative to the point of intersection 200. Similarly, a ferromagnetic flux conducting member 16cd is disposed radially outward of the poles 12c and 12d relative to the point of intersection 200. The ferromagnetic flux conducting members 16ab and 16cd are ferromagnetic “caps” and are described in further detail below. In an alternative embodiment, the flux conducting members 16ab and 16cd may each be made up of two separate cap components.

In the embodiment shown in FIG. 1, each of the quadrants 10a,b,c,d is structurally identical to each of the other quadrants 10a,b,c,d. For convenience, hereinafter, the skilled reader can assume that features of the quadrupole magnet 10 described in relation to quadrant 10a can be interpreted as being equally applicable to any of the four quadrants 10a,b,c,d (unless otherwise stated) where like numerals are used for equivalent features with the letters a, b, c and d denoting the relevant quadrant 10a, 10b, 10c and 10d respectively. In alternative embodiments, the quadrants may not all be identical to one another. Indeed, in any general multipole magnet according to an embodiment of the present invention, the poles, permanent magnets and ferromagnetic flux conducting members may be different to one another.

The permanent magnet 14ab is arranged across the quadrants 10a and 10b to supply a magnetomotive force to the ferromagnetic poles 12a and 12b (via the pole roots 13a and 13b respectively) to produce a magnetic field that extends along the pole plane into the beamline space , thereby being capable of deflecting, focusing or otherwise altering one or more characteristics of a beam of charged particles passing therethrough. The poles 12a and 12b are shaped to provide the required spatial variation of magnetic flux density across the beamline space. In alternative embodiments of the present invention, the pole shape may be somewhat different to the pole 12a of FIG. 1 to provide a different distribution of magnetic flux. The pole 12a, having a depth transverse to the pole plane, will also produce magnetic flux that is distributed beyond the pole plane (i.e. it will have a z-component), although the extent of the distribution will be largely dependent on the shape and orientation of the pole 12a. In the embodiment shown in FIG. 1, the pole 12a extends away from the pole root 13a in both the x and y directions towards the beamline space.

The ferromagnetic cap 16ab is spaced apart from the pole root 13a such that the cap 16ab and the pole root 13a are not in contact with one another. The cap 16ab is arranged to channel the magnetic flux produced by the permanent magnet 14ab and is, itself, not a pole. The purpose of the cap 16ab is to direct the magnetic flux produced by the permanent magnet 14ab to reduce the magnetic field strength in the beamline space. The closer the cap 16ab is to the permanent magnet 14ab, the weaker the magnetic field strength in the beamline space.

The permanent magnet 14ab is moveable within the pole plane along direction 18ab (which is parallel to the y-axis and orientated at 45° relative to the pole axis 100ac) so as to vary the relative distance between the permanent magnet 14ab and the poles 12a and 12b and pole roots 13a and 13b, and the permanent magnet 14ab and the cap 16ab. The permanent magnet 14ab is moveable from a first position where a first surface (substantially parallel to the y-axis) of the permanent magnet 14ab contacts a surface of each of the pole roots 13a and 13b (as shown in FIG. 1), to a second position where a second surface (substantially parallel to the x-axis) of the permanent magnet 14ab abuts against a surface of the cap 16ab. In the first position, the permanent magnet 14ab is not in physical contact with the cap 16ab, and in the second position, the permanent magnet 14ab is not in physical contact with the pole roots 13a and 13b. However, in both of the first and second positions, magnetic flux from the permanent magnet 14ab permeates the cap 16ab, the pole roots 13a and 13b and the poles 12a and 12b. The permanent magnet 14ab forms a sliding fit with the contacting surface of the pole roots 13a and 13b so that movement between the first and second positions is possible.

Movement of the permanent magnet 14ab along direction 18ab varies the magnitude of magnetic flux in the cap 16ab, the pole roots 13a and 13b and the poles 12a and 12b which ultimately varies the magnetic flux across the beamline space. Therefore, the magnetic field strength within the beamline space can be adjusted by movement of the permanent magnet 14ab along direction 18ab. The profile of the gradient of magnetic field strength with respect to displacement of the permanent magnet 14ab along direction 18ab is found to depend on the arrangement and geometry of each of the poles 12a and 12b, the pole roots 13a and 13b, the permanent magnet 14ab and the cap 16ab.

In a substantially equal manner, the permanent magnet 14cd is moveable relative to the cap 16cd, the pole roots 13c and 13d and the pole 12c and 12d to vary the magnitude of magnetic flux across the beamline space. In the embodiment shown in FIG. 1, the pole 12a and pole root 13a form a single body, whereas in alternative embodiments, the pole 12a and pole root 13a may be separately formed such that the pole root 13a is moveable relative to the pole 12a. In further alternative embodiments, any, or all, of the permanent magnets 14ab and 14cd, the pole roots 13a,b,c,d and the caps 16ab,cd may be arranged so as to be moveable relative to the poles 13a,b,c,d to vary the magnitude of magnetic flux across the beamline space.

The quadrants 10a and 10b form a first magnetic circuit of magnetic flux while the quadrants 10c and 10d form a second magnetic circuit of magnetic flux. Due to the pairing of quadrant 10a with quadrant 10b, and the pairing of quadrant 10c with 10d, the quadrupole magnet 10 extends along the y-axis in the pole plane to a greater extent than it extends along the x-axis in the pole plane. Therefore, the quadrupole magnet 10 of FIG. 1 has a generally rectangular profile in a cross section taken along the pole plane. In alternative embodiments, other pairings of poles and quadrants (or, more generally, “sectors” in other multipole magnets) are possible within the scope of the present invention. Consequently, other shapes and geometries are possible across the pole plane. Indeed, the present invention permits a multipole magnet of suitable strength and (optionally) adjustability to be made within a relatively small volume when compared to multipole magnets of similar strength in the prior art.

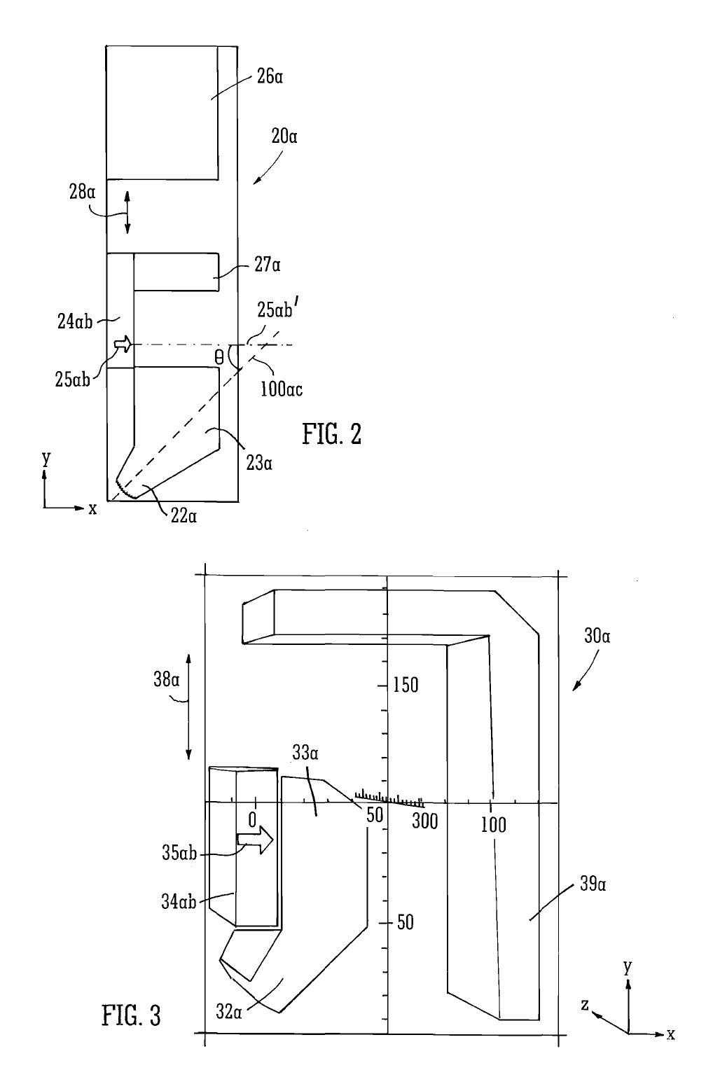

Further embodiments of the invention are described hereinafter with reference to FIGS. 2 to 9 which show examples of specific arrangements and geometries that are found to be particularly advantageous. For convenience, the further embodiments are described with reference to a single quadrant of a quadrupole magnet, however, all described features are applicable to corresponding quadrants of the quadrupole magnet.

FIG. 2 shows a quadrant 20a of an alternative embodiment of a quadrupole magnet according to the present invention. Like the embodiment shown in FIG. 1, the quadrant 20a comprises a stationary ferromagnetic pole 22a formed with or connected to a pole root 23a, a stationary ferromagnetic cap 26a spaced vertically from the pole root 23a, and part (since it extends into quadrant 20b) of a permanent magnet 24ab moveable along direction 28a (parallel to the y-axis) relative to the pole 22a, the pole root 23a and the cap 26a. In this embodiment, an additional ferromagnetic flux conducting member 27a is present in the quadrant 20a (and the other quadrants also) that is also moveable along direction 28a relative to the pole 22a, pole root 23a and cap 26a. The permanent magnet 24ab and the flux conducting member 27a are together moveable to form a close-fit with two complementary sides of the pole root 23a when moved against it. The permanent magnet 24ab has a direction of magnetisation 25ab (or “magnetisation direction”) along which the magnetic moments of the permanent magnet 24ab lie. The magnetisation direction lies parallel to a magnetisation axis 25ab′ that forms an angle θ (=45°) with the pole axis 100ac, as shown in FIG. 2. For the avoidance of doubt, the angle θ is subtended by a notional line intersecting both the magnetisation axis 25ab and the pole axis 100ac that lies at least partly in the quadrant 20b. Similarly, the angle θ in quadrant 20b would be the angle subtended by a notional line intersecting both the magnetisation axis 25ab and the pole axis 100bd that lies at least partly in the quadrant 20a. Equivalently, the angle θ in quadrant 20c would be the angle subtended by a notional line intersecting both the magnetisation axis 25cd and the pole axis 100ac that lies at least partly in the quadrant 20d; and the angle θ in quadrant 20d would be the angle subtended by a notional line intersecting both the magnetisation axis 25cd and the pole axis 100bd that lies at least partly in the quadrant 20c.

FIG. 3 shows a further alternative quadrant 30a which comprises a stationary ferromagnetic pole 32a formed with or connected to a pole root 33a, a stationary ferromagnetic flux conducting member in the form of an L-shaped shell-piece 39a spaced from the pole 32a and pole root 33a, and part of a permanent magnet 34ab moveable relative to the pole 32a and the shell-piece 39a along direction 38a (parallel to the y-axis). When considering all four quadrants 30a,b,c,d together (not shown), the shell-pieces 39a,b,c,d form a discontinuous shell 39 around the poles 32a,b,c,d in the pole plane. As the shell-piece extends above or below the respective pole roots, it may be considered to incorporate the caps 16ab, cd shown in FIG. 1. The flux conducting members may include a cap 16ab, cd and an L-shaped shell-piece or may be unitarily formed as shown in FIG. 3.

In any of the embodiments shown in FIGS. 1 to 2, the ferromagnetic flux conducting members 16a,26a, may move in addition to or instead of the permanent magnets 14ab,24ab to vary the magnitude of the magnetic field strength in the beamline space. In the case where the both the flux conducting member 16a,26a and the permanent magnets 14ab,24ab move, they may do so independently of one another such that relative movement is permitted therebetween, or they may do so together such that no relative movement is permitted therebetween.

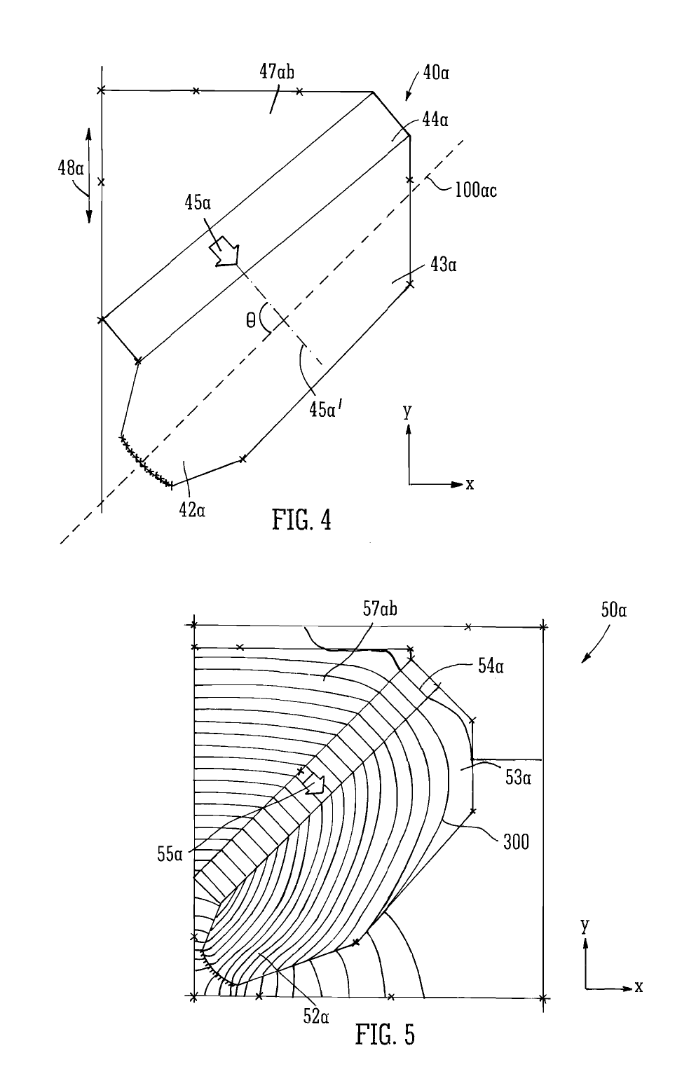

Further preferable embodiments of the invention are shown in FIGS. 4 to 7 which demonstrate several examples of how the magnetisation direction of the permanent magnets might be orientated with respect to the pole axes.

In FIG. 4, a quadrant 40a is shown which comprises a ferromagnetic pole 42a and a connected pole root 43a, a ferromagnetic flux conducting member 47ab and a permanent magnet 44a arranged therebetween along the pole plane. In this embodiment, the quadrant 40a contains a single permanent magnet 44a and equivalent quadrants 40b,c,d will contain substantially identical permanent magnets 44b,c,d respectively. The permanent magnet 44a is orientated such that in the pole plane, the magnetisation axis 45a′ of the permanent magnet 44a forms an angle of θ (=95°) relative to the pole axis 100ac of the pole 42a. The ferromagnetic flux conducting member 47ab extends across both quadrants 40a and 40b and forms a magnetic “bridge” therebetween. The bridge 40a,b is arranged in a gap between the respective permanent magnets. Each bridge 40a,b may be formed by one or more ferromagnetic components. In the embodiment shown in FIG. 4, the permanent magnet 44a and the bridge 47ab may be moveable relative to the pole 42a and pole root 43a along a direction 48a, together with the remaining part of the bridge 47ab (in quadrant 40b) and the permanent magnet 44b.

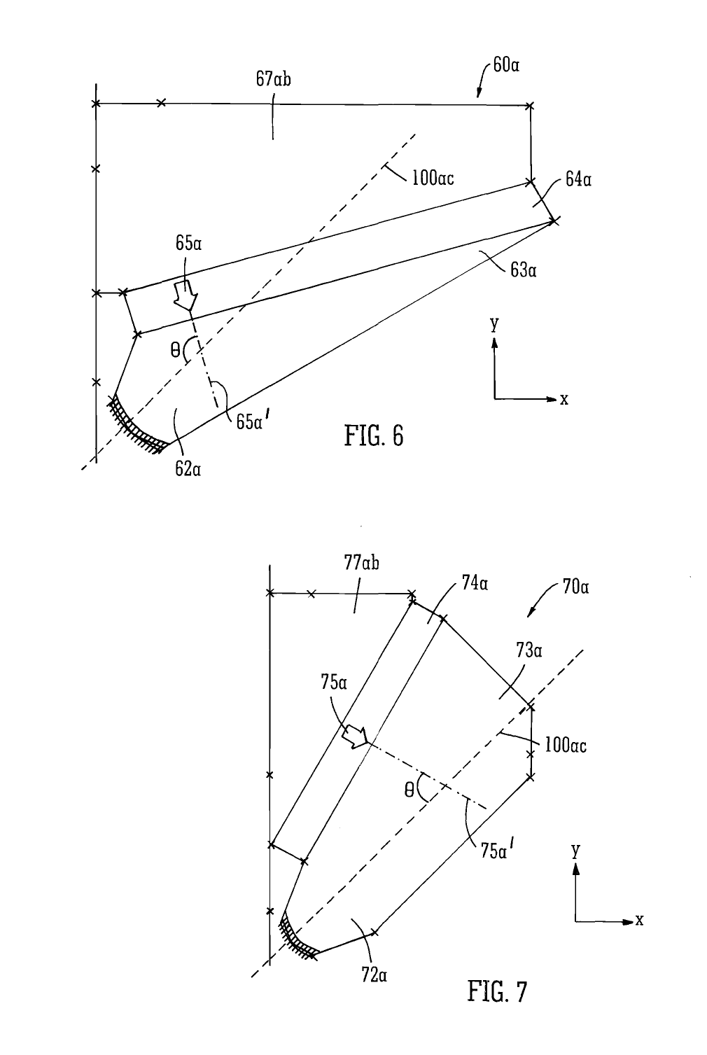

FIG. 5 shows a quadrant 50a that is similar to the quadrant 40a of FIG. 4, comprising a ferromagnetic pole 52a formed with or connected to a pole root 53a, a ferromagnetic bridge 57a and a permanent magnet 54a arranged therebetween along the pole plane. Again, in the pole plane, the magnetisation direction 55a of the permanent magnet 54a forms an angle with the pole axis 100ac of the pole 42a. FIG. 5 shows the lines of magnetic flux 300 produced by the permanent magnet 54a demonstrating their distribution in the ferromagnetic pole 52a, pole root 53a and bridge 57a through which they permeate. An alternative quadrant 60a is shown in FIG. 6 comprising a ferromagnetic pole 62a, a ferromagnetic bridge 67a and a permanent magnet 64a arranged therebetween in the pole plane. The magnetisation axis 65a′ of the permanent magnet 64a forms an angle of θ (=120°) with the pole axis 100ac in the pole plane. A further alternative quadrant 70a is shown in FIG. 7. Again, the quadrant 70a comprises a ferromagnetic pole 72a, a ferromagnetic bridge 77a and a permanent magnet 74a arranged therebetween in the pole plane. In this embodiment, the magnetisation axis 75a′ of the permanent magnet 74a forms an angle of θ (=75°) with the pole axis 100ac in the pole.

In the embodiments of FIGS. 4 to 7, the poles 42a,52a,62a,72a are each connected to a pole root 43a,532a,632a,73a, however due to the relative orientation of the permanent magnets 44a,54a,64a,74a, the distinction between the pole roots 43a,53a,63a,73a and the poles 42a,52a,62a,72a is less well defined compared with the poles 12a,22a,32a of the embodiments of FIGS. 1 to 3.

Movement of the bridge portions, with or without the permanent magnets, creates an air gap which has the effect of reducing the strength of the magnetic field in the beamline space.

Preferably, the permanent magnet and/or the flux conducting members is/are moveable relative to the pole and pole root (although the pole root may also be moveable). In particularly preferable embodiments, the flux conducting member (e.g. bridge) and permanent magnet are moveable together, such that no relative movement is permitted therebetween. Preferably, the direction of movement of the flux conducting member and permanent magnet along the pole plane is at 45° relative to the pole axis (i.e. parallel to the y-axis in the embodiments shown in FIGS. 4 to 7). In any embodiment, movement of the permanent magnets and/or flux conducting members may be driven by one or more motors mounted to the multipole magnet. In alternative embodiments, the moveable parts may be moved by any suitable actuation means and may be hydraulic or pneumatic, for example. The force required to move the permanent magnet and/or flux conducting members will depend on the magnetic strength and direction of magnetisation of the permanent magnet, the relative orientation of the pole, permanent magnet and flux conducting members, and the direction of movement of the permanent magnet and/or flux conducting members.

Permanently magnetic materials are generally known to be mechanically poor under tension. Therefore, to improve the mechanical strength of the permanent magnets of the present invention, one or more steel plates may be attached by glue or any other suitable attachment means to the permanent magnets. This minimizes the risk of the permanent magnets being structurally damaged as they are mechanically moved relative to the poles. The attachment means may additionally or alternatively include straps wrapped around the steel plates and the permanent magnets.

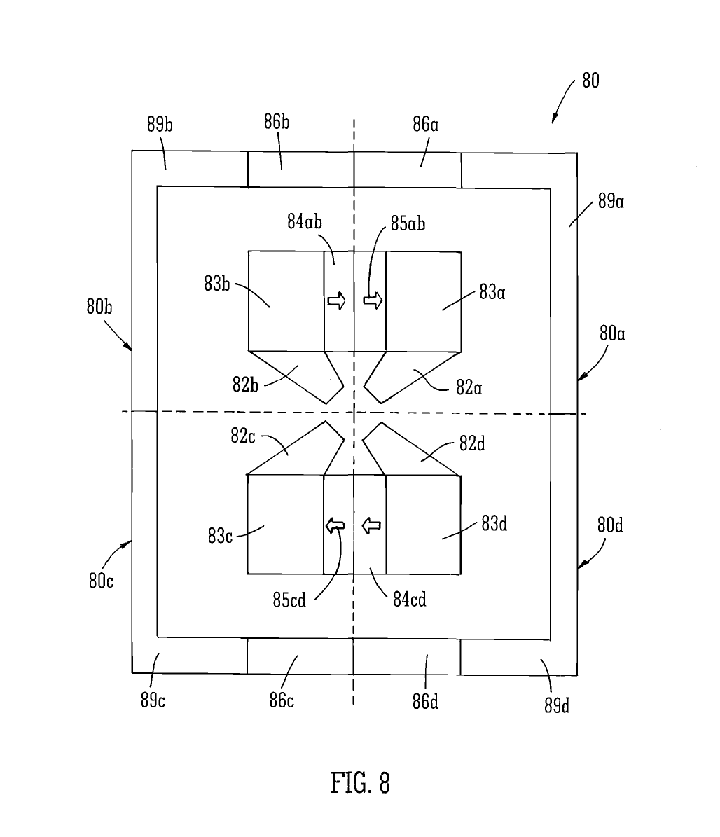

FIG. 8 shows a complete cross section of four quadrants 80a,b,c,d of an alternative embodiment of a four-pole quadrupole magnet 80 according to the present invention. The embodiment shown in FIG. 8 is largely similar to the embodiment shown in FIG. 1 except that the embodiment of FIG. 8 comprises four separate caps 86a,b,c,d and additionally comprises four shell-pieces 89a,b,c,d (which are all ferromagnetic flux conducting members) forming a continuous shell with the caps 86a,b,c,d that surrounds the poles 82a,b,c,d. Whilst the caps 86a,b,c,d are moveable relative to the poles 82a,b,c,d, the shell-pieces 89a,b,c,d are not. The shell 89a,b,c,d effectively “short-circuits” the magnetic flux from the permanent magnets 84ab,84cd when they are moved to a position that is fully out from between the pole roots 93a,b,c,d (and possibly in contact with the caps 86a,b,c,d). Additionally, the shell 89a,b,c,d helps to reduce the amount of stray field outside of the quadrupole magnet 80.

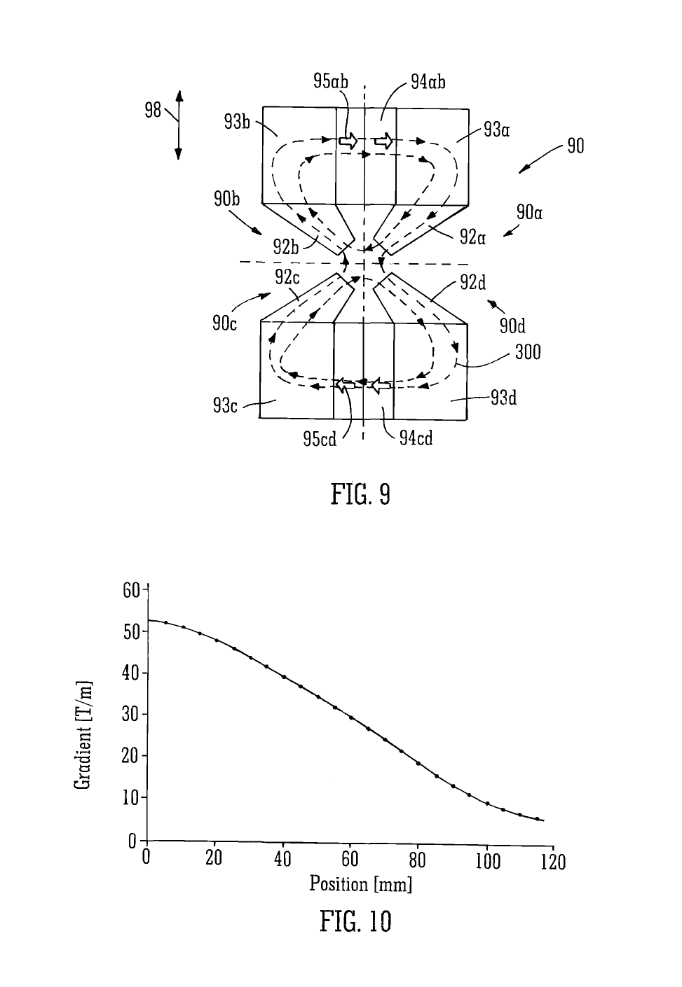

FIG. 9 shows a similar embodiment of a quadrupole magnet 90 (with no caps or shell-pieces shown), and indicates the lines of magnetic flux 300. As described above, the permanent magnets 94ab and 94cd create a magneto-motive force that creates flux circuits between the poles 92a and 92b, and 92c and 92d. The flux circuits between the pairs of poles are not isolated from one another, but flow along the lines 300 indicated in FIG. 9 such that the circuit connects all of the poles 92a,b,c,d and passes through the beamline space.

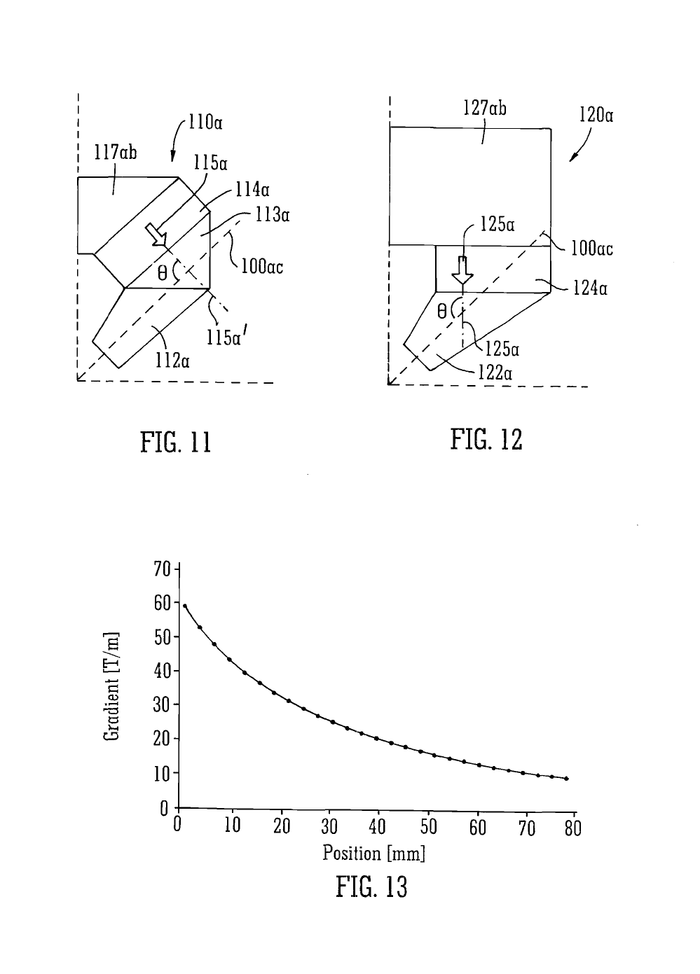

FIG. 10 shows a plot of the change of magnetic field strength in the beamline space in relation to the displacement of the permanent magnets of FIGS. 9 parallel to direction 98. As can be seen from FIG. 10, the magnetic field strength in the beamline space decreases as the permanent magnets are moved further away from the poles, as one might expect. However, it can also be seen in FIG. 10 that the arrangement of the present invention advantageously allows a smooth and steady change in magnetic field strength in the beamline space as the permanent magnets are displaced. Further embodiments of the present invention are shown in FIGS. 11 and 12 which each show a quadrant (110a and 120a, respectively) of a four-pole multipole magnet. In FIG. 11, the angle θ between the magnetisation axis 115a′ and the pole axis 100ac is 90°. In the embodiment of FIG. 12, the angle θ between the magnetisation axis 125a′ and the pole axis 100ac is 135°. Both of these embodiments include a bridge 117ab and 127ab that completes the magnetic circuit between the quadrants 110a and 110b, and 120a and 120b respectively.

FIG. 13 shows a plot of the change of magnetic field strength in the beamline space in relation to the displacement of the permanent magnet 44a of FIGS. 4 parallel to direction 48. In contrast to the plot of FIG. 10, the magnetic field strength in the plot of FIG. 13 drops off more sharply in response to initial displacement of the permanent magnet 44a from the pole 42a, with the rate of decrease gradually decreasing as absolute displacement of the permanent magnet 44a increases. All the while, however, the change in magnetic field strength is smooth. The above described embodiments allow the multipole magnet to produce a magnetic field that is highly adjustable compared to multiple magnets of the prior art. As a result of the described arrangements and geometries, the present invention affords the possibility of producing multipole magnets that can produce high quality, adjustable magnetic fields that are relatively compact in volume compared to prior art multipole magnets. This is particularly important when considering use of multipole magnets in confined spaces such as the tunnels that many particle accelerators reside in. In a particularly preferable embodiment of the present invention, the largest dimension of the multipole magnet along the pole plane is less than a predetermined size, such as 390 mm. The features of the present invention allow a multipole magnet of this size to be capable of producing an adjustable magnetic field of sufficient strength.

Throughout the description and claims of this specification, the word “ferromagnetic” and variations thereof are synonymous with the terms “magnetically soft” and “magnetically permeable” and refer to reasonably high permeability of at least 10 μₒ, where μₒ is the permeability of free space. For the purpose of the present invention, one suitable ferromagnetic material is steel, however other suitable ferromagnetic materials may also be used.

Throughout the description and claims of this specification, the terms “magnetic field strength” and “field amplitude” and variations of these terms are substantially equivalent to the magnetic flux density for the purpose of the present application, whatever its spatial distribution.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A multipole magnet for deflecting a beam of charged particles, comprising:
a plurality of ferromagnetic poles arranged in a pole plane;
a plurality of permanent magnets each having a magnetisation direction, and each being arranged to supply magnetomotive force to the plurality of ferromagnetic poles to produce a magnetic field along the pole plane in a beamline space between the poles; and
a plurality of ferromagnetic flux conducting members arranged to channel magnetic flux from at least one of the plurality of permanent magnets; wherein the multipole magnet comprises an even number of ferromagnetic poles, each pole being arranged to diametrically oppose another of the poles in the pole plane along a pole axis, wherein each of the plurality of permanent magnets is associated with at least one of the plurality of poles and the magnetisation direction of each permanent magnet is orientated in the pole plane at an angle of at least 45° relative to the pole axis of the associated pole.

2. A multipole magnet according to claim 1, wherein the magnetisation direction of each permanent magnet is orientated in the pole plane at an angle of less than or equal to 135° relative to the pole axis of the associated pole.

3. A multipole magnet according to claim 1, wherein the magnetisation direction of each permanent magnet is orientated in the pole plane at an angle of 75° relative to the pole axis of the associated pole.

4. A multipole magnet according to claim 1, wherein the magnetisation direction of each permanent magnet is orientated in the pole plane at an angle of at least 90° relative to the pole axis of the associated pole.

5. A multipole magnet according to claim 4, wherein the magnetisation direction of each permanent magnet is orientated in the pole plane at an angle of 120° relative to the pole axis of the associated pole.

6. A multipole magnet according to claim 1, wherein at least one of the plurality of permanent magnets and the plurality of ferromagnetic flux conducting members is moveable in the pole plane relative to the plurality of ferromagnetic poles so as to vary the strength of the magnetic field in the beamline space.

7. A multipole magnet according to claim 6 wherein each ferromagnetic flux conducting member is in a spaced arrangement from an associated ferromagnetic pole, and only the plurality of permanent magnets are moveable in the pole plane relative to the ferromagnetic poles.

8. A multipole magnet according to claim 6, wherein each permanent magnet is moveable in the pole plane together with an associated ferromagnetic flux conducting member relative to an associated ferromagnetic pole such that substantially no relative movement between each permanent magnet and its associated ferromagnetic flux conducting member is permitted.

9. A multipole magnet according to claim 6, wherein the at least one of the plurality of permanent magnets and the plurality of ferromagnetic flux conducting members are moveable along the pole plane along a path orientated at an angle of 45° relative to the pole axis of the associated pole.

10. A multipole magnet according to claim 2, wherein the magnetisation direction of each permanent magnet is orientated in the pole plane at an angle that is greater than 45° relative to the pole axis of the associated pole, and each of the plurality of permanent magnets is associated with one of the plurality of poles; and at least some of the ferromagnetic flux conducting members comprise ferromagnetic bridges that channel magnetic flux between the permanent magnets of two adjacent poles.

11. A multipole magnet for deflecting a beam of charged particles, comprising:
a plurality of ferromagnetic poles arranged in a pole plane;
a plurality of permanent magnets arranged to supply magnetomotive force to at least one of the plurality of ferromagnetic poles to produce a magnetic field along the pole plane in a beamline space between the poles; and
a plurality of ferromagnetic flux conducting members arranged to channel magnetic flux from at least one of the plurality of permanent magnets; wherein at least one of the plurality of permanent magnets and the plurality of ferromagnetic flux conducting members is moveable in the pole plane relative to the plurality of ferromagnetic poles so as to vary the strength of the magnetic field in the beamline space.

12. A multipole magnet according to claim 11 wherein each ferromagnetic flux conducting member is in a spaced arrangement from an associated ferromagnetic pole, and only the plurality of permanent magnets are moveable in the pole plane relative to the ferromagnetic poles.

13. A multipole magnet according to claim 11, wherein each permanent magnet is moveable in the pole plane together with an associated ferromagnetic flux conducting member relative to an associated ferromagnetic pole such that substantially no relative movement between each permanent magnet and its associated ferromagnetic flux conducting member is permitted.

14. A multipole magnet according to claim 11, comprising an even number of ferromagnetic poles, each pole being arranged to diametrically oppose another of the poles in the pole plane along a pole axis.

15. A multipole magnet according to claim 14, wherein the at least one of the plurality of permanent magnets and the plurality of ferromagnetic flux conducting members are moveable along the pole plane along a path orientated at an angle of 45° relative to the pole axis of the associated pole

16. A multipole magnet according to claim 14, wherein each of the plurality of permanent magnets has a magnetisation direction, and each permanent magnet has at least one of the plurality of poles associated with it, where the magnetisation direction of each permanent magnet is orientated in the pole plane at an angle of at least 45° relative to the pole axis of the associated pole.

17. A multipole magnet according to claim 16, wherein the magnetisation direction of each permanent magnet is orientated in the pole plane at an angle of less than or equal to 135° relative to the pole axis of the associated pole.

18. A multipole magnet according to claim 16, wherein the magnetisation direction of each permanent magnet is orientated in the pole plane at an angle of 75° relative to the pole axis of the associated pole.

19. A multipole magnet according to claim 16, wherein the magnetisation direction of each permanent magnet is orientated in the pole plane at an angle of at least 90° relative to the pole axis of the associated pole.

20. A multipole magnet according to claim 19, wherein the magnetisation direction of each permanent magnet is orientated in the pole plane at an angle of 120° relative to the pole axis of the associated pole.

21. A multipole magnet according to claim 17, wherein the magnetisation direction of each permanent magnet is orientated in the pole plane at an angle that is greater than 45° relative to the pole axis of the associated pole, and each of the plurality of permanent magnets is associated with one of the plurality of poles; and at least some of the ferromagnetic flux conducting members comprise ferromagnetic bridges that channel magnetic flux between the permanent magnets of two adjacent poles.

22. A multipole magnet according to claim 1, wherein at least some of the ferromagnetic flux conducting members comprise a cap associated with at least one of the permanent magnets to channel magnetic flux therefrom.

23. A multipole magnet according to claim 1, wherein at least some of the ferromagnetic flux conducting members comprise a discontinuous shell surrounding the poles and permanent magnets.

24. A multipole magnet according to claim 1, wherein the sum of ferromagnetic poles and ferromagnetic flux conducting members is greater than the number of permanent magnets.

25. A multipole magnet according to claim 1, wherein the multipole magnet is a quadrupole magnet comprising four ferromagnetic poles and two permanent magnets, wherein each of the two permanent magnets is associated with two of the poles to supply magnetomotive force thereto.

26. A multipole magnet according to claim 1, wherein the multipole magnet is a quadrupole magnet comprising four ferromagnetic poles and four permanent magnets, wherein each of the permanent magnets is associated with one of the poles to supply magnetomotive force thereto.

27. (canceled)
